(19) United States
(12) Patent Application Publication
(10) Pub. No.: US 2015/0167583 A1
(43) Pub. Date: Jun. 18, 2015

(54) EXHAUST PASSAGE STRUCTURE FOR INTERNAL COMBUSTION ENGINE

(71) Applicants: Hironobu Sakamoto, Toyota-shi (JP); Nobuhiko Horie, Toyota-shi (JP); Tatsuo Shitara, Okazaki-shi (JP)

(72) Inventors: Hironobu Sakamoto, Toyota-shi (JP); Nobuhiko Horie, Toyota-shi (JP); Tatsuo Shitara, Okazaki-shi (JP)

(73) Assignee: TOYOTA JIDOSHA KABUSHIKI KAISHA, Toyota-shi, Aichi-ken (JP)

(21) Appl. No.: 14/411,809

(22) PCT Filed: Sep. 27, 2013
(86) PCT No.: PCT/IB2013/002234

§ 371 Date: Dec. 29, 2014

(30) Foreign Application Priority Data
Oct. 1, 2012 (JP) 2012-219679

(51) Int. Cl. F02F 1/42; F01N 13/00; F02F 1/24

(52) U.S. Cl. CPC F02F 1/4264; F02F 1/243; F01N 13/001; F02F 2001/4278

(57) ABSTRACT

Inner exhaust passages are provided with three or more curve through that extend toward downstream sides of exhaust gas flow and alternately curve to one side and the other side in directions of a cylinder center line.

### BACKGROUND OF THE INVENTION

1. Field of the Invention

The present invention relates to an exhaust passage structure for an internal combustion engine, and more particularly to the shape of the passages that respectively communicate with multiple cylinders.

2. Description of Related Art

In a multi-cylinder internal combustion engine (hereinafter referred to as an engine) mounted on a vehicle, exhaust passages that respectively communicate with cylinders on outer sides in a cylinder row direction widely curve toward inner sides and have a certain length to a collecting portion, while other exhaust passages that communicate with the cylinders on inner sides in the cylinder row direction extend generally linearly when viewed in a direction of a cylinder center line and tend to be shortened in comparison with outer exhaust passages.

Therefore, a heat radiation property relatively deteriorates in inner exhaust passages, and durability reliability of a catalyst or other components provided in the exhaust passages can possibly deteriorate in an operational state where the heat quantity of the exhaust gas increases, for example, in a high-load and high-speed operation. On the other hand, in a situation in which the warm-up of the catalyst is desirably accelerated at a cold start, for example, the temperature of the exhaust gas flowing in the outer exhaust passages may decrease.

In addition, when the temperature of the exhaust gas flowing in the outer exhaust passages is largely different from the temperature of the exhaust gas flowing in the inner exhaust passages, the exhaust gas temperature largely fluctuates in the exhaust passages on a downstream side where the exhaust passages merge with each other. Therefore, an abnormality of a sensor provided at an upstream side of the catalyst can be determined falsely.

In this regard, an exhaust manifold (collecting pipe) disclosed in Japanese Patent Application Publication No. 63-219987 (JP 63-219987 A) includes four pipe bodies that respectively communicate with four cylinders of an in-line four-cylinder engine, and the downstream sides of two pipe bodies communicating with two outer cylinder and the downstream sides of two pipe bodies communicating with two inner cylinder are arranged to be vertically stacked with each other in two rows. That is, the inner pipe bodies are opened above the openings of the outer pipe bodies in a collecting member.

In other words, the inner pipe bodies has vertically curving shapes so as to extend over the outer pipe bodies, and the openings on the downstream ends are arranged away from ceiling portions of the cylinders (namely, upstream ends of the inner pipe bodies) in the vertical direction. Thus, it is considered that the inner pipe bodies are elongated accordingly, the difference with the length of the outer pipe bodies decreases, and the temperature difference between the exhaust gas flowing in the inner pipe bodies and the exhaust gas flowing in the outer pipe bodies may decrease.

However, in the related art, when the length of the inner pipe bodies is hypothetically needed to be conformed to that of the outer pipe bodies, the inner pipe bodies are required to be curved so as to largely protrude in the vertical direction, and size of the overall exhaust manifold tends to increase.

Generally, there is a demand for the securement of discharging efficiency of the exhaust gas with a high flow rate (namely, low pressure loss) for the exhaust gas passages. In this regard, it is not preferable that the inner pipe bodies which can be shortened in general be elongated to the same length as the outer pipe bodies purposely.

In recent years, the exhaust manifold is formed with the cylinder head as one unit, and exhaust ports (exhaust passages) for each cylinder are collected in the cylinder head. In such a case, the upsizing of the exhaust manifold directly results in the upsizing and weight increase of the cylinder head.

Furthermore, when the heat radiation property of the exhaust port in the cylinder head is needed to be improved, the volume or flow rate of coolant in the water jackets may tend to increase. In this regard, disadvantages such that the overall weight increases and the load of a water pump for supplying the coolant increases may arises.

### SUMMARY OF THE INVENTION

The object of the present invention is to reduce the temperature difference of the exhaust gas between the inner passage and the outer passage of the internal combustion engine with an ingenious shape of the exhaust passage (inner passage) that communicate with the cylinder of the inner side in the cylinder row direction and by improving the heat radiation property of the exhaust passage without capsizing the overall exhaust passage in vain.

One aspect of the present invention relates to a structure of exhaust passages that respectively communicate with three or more cylinders of an internal combustion engine. The exhaust passages include two outer passages that respectively communicate with the cylinders on outer sides in a cylinder row direction. The outer passages extend toward downstream sides of exhaust gas flow and curves to approach inner sides in the cylinder row direction. The exhaust passage further includes an inner passage that communicates with the cylinder on inner sides in the cylinder row direction. The inner passage has three or more curves each of which is a first curve having a center of curvature at a position closer to a cylinder center line than the exhaust gas flowing in the first curve or a second curve having a center of curvature at a position farther from the cylinder center line than the exhaust gas flowing in the second curve, the first curve and the second curve being located alternately in a direction toward the downstream sides of the exhaust gas flow.

According to the aforementioned aspect, the inner passages that tend to be shortened in comparison with the outer passages are provided with at least three or more curves each of which is a first curve having a center of curvature at a position closer to a cylinder center line than the exhaust gas flowing in the first curve or a second curve having a center of curvature at a position farther from the cylinder center line than the exhaust gas flowing in the second curve, the first curve and the second curve being located alternately in a direction toward the downstream sides of the exhaust gas flow. The exhaust gas flow that flows in the inner passage collides with wall surfaces of outer sides in the respective curves, and the heat radiation property is improved by turbulent diffusion. The inner passage curves in the direction of a cylinder axis but may have at least a curve which curves in the direction of the cylinder axis.

Accordingly, because the heat radiation property can be improved in the three or more curves, the inner passage can secure a high heat radiation property without having a length as the outer passages does, and the temperature difference of the exhaust gas between the inner passage and the outer passage can be reduced without upsizing the overall exhaust passage. In addition, when the curvature of the passage in the curve is not small, the pressure loss of the flow does not increase so much.

Outer cylinders and inner cylinder in the cylinder row direction herein mean that respective cylinders on outer sides are the outer cylinders and one cylinder in the middle is the inner cylinder in a case of an in-line three-cylinder engine, and the respective cylinders on the outer sides are the outer cylinders and two cylinders in the middle are the inner cylinders in a case of an in-line four-cylinder engine. In a V-type engine or a horizontally opposed engine, the inner side and the outer side are determined similarly to the above description for each bank.

In the above aspect of the present invention, a step may be provided on a wall surface of an outer side of the curve in at least one of three or more curves in the inner passage so as to be shaped into steps along a direction of the exhaust gas flow. According to the aspect, turbulence of the exhaust gas flow that collides with the wall surface of the outer side of the curve is further enhanced, and the enhancing effect of the heat radiation property by the turbulent diffusion is improved more.

Particularly, the step is preferably provided in the curve on an extreme downstream side of the exhaust gas flow out of three or more curves. This is because the exhaust gas can flow backward in the exhaust passages due to pulsation of the exhaust gas flow, and thus the exhaust gas flow exists in the curve on the extreme downstream side in a steady state, and an enhancing effect of the heat radiation property by the turbulent diffusion is further improved.

When the exhaust passages, that is to say, the inner passage and the outer passages are all formed in the cylinder head of the internal combustion engine, a water jacket may be provided in a vicinity of the wall surface of the outer side of the curve in at least one of three or more curves in the inner passage. The water jacket may be provided in a vicinity of the downstream side of the exhaust gas flow in the curves (that is, portions where the exhaust gas flow collides with the wall surfaces of the outer sides of the curves).

Accordingly, the portion of the inner passage with improved heat radiation property by the turbulent diffusion of the exhaust gas flow are effectively cooled by the coolant in the water jacket, and cooling efficiency for the exhaust gas can be improved. Therefore, volume or flow rate of the coolant in the water jacket can be reduced. This contributes to the reduction of weight of the internal combustion engine, and also the load of the water pump can be reduced.

In addition, the water jacket may be provided in a vicinity of the curve on the extreme downstream side of the exhaust gas flow out of three or more curves. As described above, this is because the exhaust gas flow exists in the curve on the extreme downstream side in a steady state and an enhancing effect of the heat radiation property by the turbulent diffusion is further improved.

Furthermore, the downstream ends of the exhaust gas flow in the two outer passages may be adjacently opened in a side wall of the cylinder head in the cylinder row direction, and the downstream end of the exhaust gas flow in the inner passage may be opened on a far side from the cylinders in the directions of the cylinder center line with respect to downstream end openings of the outer passages in the side wall.

Accordingly, the downstream end of the inner passage is arranged away from a communicating portion with cylinder (namely, upstream ends) in the direction of the cylinder center line, and the length of the passages is elongated accordingly. Therefore, the difference in the length with the outer exhaust passages is reduced, and the temperature difference of the exhaust gas can be reduced.

According to the exhaust passage structure of one aspect of the present invention, the inner passage which tends to be shortened in comparison with the outer passages in the cylinder row direction has at least three curves each of which is a first curve having a center of curvature at a position closer to a cylinder center line than the exhaust gas flowing in the first curve or a second curve having a center of curvature at a position farther from the cylinder center line than the exhaust gas flowing in the second curve, the first curve and the second curve being located alternately in a direction toward the downstream sides of the exhaust gas flow. Therefore, the heat radiation property is improved. Therefore, the temperature difference of the exhaust gas between the inner passage and the outer passage can be reduced without upsizing the overall exhaust passage in vain and without greatly losing the discharging efficiency of the exhaust gas with a high flow rate. This contributes to the securement of durability reliability of the exhaust system and the improvement of warm-up property at a cold start.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a cylinder head of an internal combustion engine according to an embodiment of the present invention that is viewed obliquely from above;

FIG. 2 is a diagram that is viewed through the cylinder head from above and illustrates an entire layout of cylinders and exhaust ports;

FIG. 3 is a diagram that is viewed from an exhaust side and illustrates a layout of entire exhaust ports;

FIG. 4 is a cross-sectional view of the cylinder head that is taken along a cylinder row direction and shows an outline of an inner exhaust port and an arrangement of water jackets;

FIG. 5 is a diagram that schematically illustrates a state in which a main stream of exhaust gas flowing in the inner exhaust port collides with curves;

FIG. 6 is a corresponding diagram of FIG. 4 according to other embodiments in which a step is provided at the curve in an extreme downstream portion; and

FIG. 7 is a corresponding diagram of FIG. 5 according to the other embodiments of the present invention.

### DETAILED DESCRIPTION OF EMBODIMENTS

Hereinafter, embodiments of the present invention will be described with reference to accompanying drawings. The present embodiment is described, as one example, in a case where the exhaust passage structure according to the present invention is applied to a gasoline engine (internal combustion engine) mounted on an automobile.

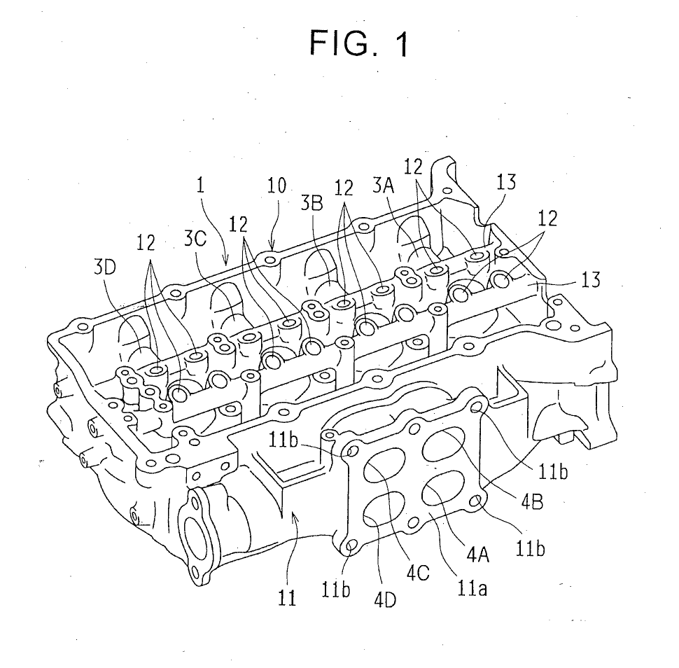

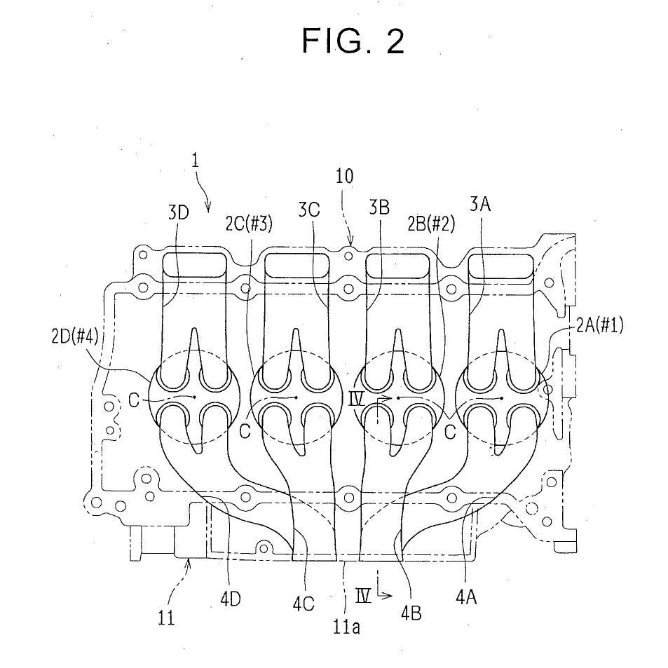

FIG. 1 is a perspective view of a cylinder head 1 of the gasoline engine according, to an embodiment of the present invention that is viewed obliquely from above. The cylinder head 1 is mounted on the top of a cylinder block (not shown) and closes upper ends of four cylinders 2 (see FIG. 2) which are foamed in the cylinder block to form a combustion chamber with a piston (not shown) which is inserted into each cylinder 2.

In the engine according to the present embodiment as one example, four cylinders 2 are arranged in line as shown in FIG. 2 that is viewed through from above and hereinafter referred to as a first cylinder 2A (#1), a second cylinder 2B (#2), a third cylinder 2C (#3), and a fourth cylinder 2D (#4) in the order from one end to the other end of the cylinder head 1 (from right to left in FIG. 2) in a longitudinal direction (that is, cylinder row direction). Although not shown, a shallow recess that is a ceiling portion of the combustion chamber for each cylinder 2 is formed in an undersurface of the cylinder head 1, and intake ports 3A through 3D and exhaust ports 4A through 4D are opened in the recess.

That is, four intake ports 3A through 3D for taking air into the respective combustion chambers in the cylinders 2 are opened, as shown in FIG. 2, in a side wall 10 of the cylinder head 1 on an intake side which is the back side in FIG. 1, and an intake manifold (not shown) is connected to the intake ports. On the other hand, four exhaust ports 4A through 4D for discharging burned gas from the respective combustion chambers in the cylinders 2 are opened in a side wall 11 of the cylinder head 1 on an exhaust side which is the front side in FIG. 1, and an exhaust manifold (not shown) is connected to the exhaust ports.

The cylinder head 1 according to the present embodiment has a structure in which a part of the exhaust manifold is formed in the side wall 11 on the exhaust side as one unit, and four exhaust ports 4A through 4D that is elongated in comparison with ordinary exhaust ports are formed in the side wall 11 on the exhaust side as described below in detail. As shown in FIG. 1, a fastener seat portion 11a in an approximately rectangular shape is formed in an approximate center in the longitudinal direction of the side wall 11 on the exhaust side, and four exhaust ports 4A through 4D are opened in the fastening seat portion 11a so that two exhaust ports are arranged in each row and column.

In other words, two outer exhaust ports 4A and 4D are adjacently opened in a lower half of the fastener seat portion 11a in the cylinder row direction, and two inner exhaust ports 4B and 4C are adjacently opened in a upper half of the fastener seat portion 11a in the cylinder row direction. Bolt holes 11b are opened at four corners and middle parts of upper and lower edges of the fastener seat portion 11a, and flanges of the exhaust manifold (not shown) are mounted and fastened onto the bolt holes 11b.

Although not shown in the drawings, a DOHC type valve train is disposed in an upper part of the cylinder head 1 in which camshafts are provided on the intake and the exhaust sides. As shown in FIG. 1, two holes 12 for hydraulic lash adjusters (HLA) are provided on each of the intake and the exhaust sides for each cylinder 2, and passages 13 are provided for supplying oil to the HLAs on the intake and the exhaust sides.

As shown in FIG. 2, when the cylinder head 1 is viewed through from above, the four exhaust ports 4A through 4D each divide into two branch pipes at the upstream end of the exhaust gas flow and respectively communicates with the cylinders 2A through 2D. On the other hand, the midstream and the downstream portion of the exhaust ports 4A through 4D do not divide into two nor merge with adjacent one of the exhaust ports 4A through 4D but extend in the side wall 11 on the exhaust side to be separately opened in the fastener seat portion 11a as described above.

The exhaust ports 4A and 4D (outer passages) out of four exhaust ports 4 which are respectively communicate with the first and the fourth cylinders 2A and 2D on the outer sides in the cylinder row directions curve with relatively large radius of curvature to gradually approach the middle in the cylinder row direction from the upstream side to the downstream side of the exhaust gas flow when viewed in a vertical direction (in a direction of a center line C of the cylinder) as shown in FIG. 2, in other words, to approach the inside in the cylinder row direction.

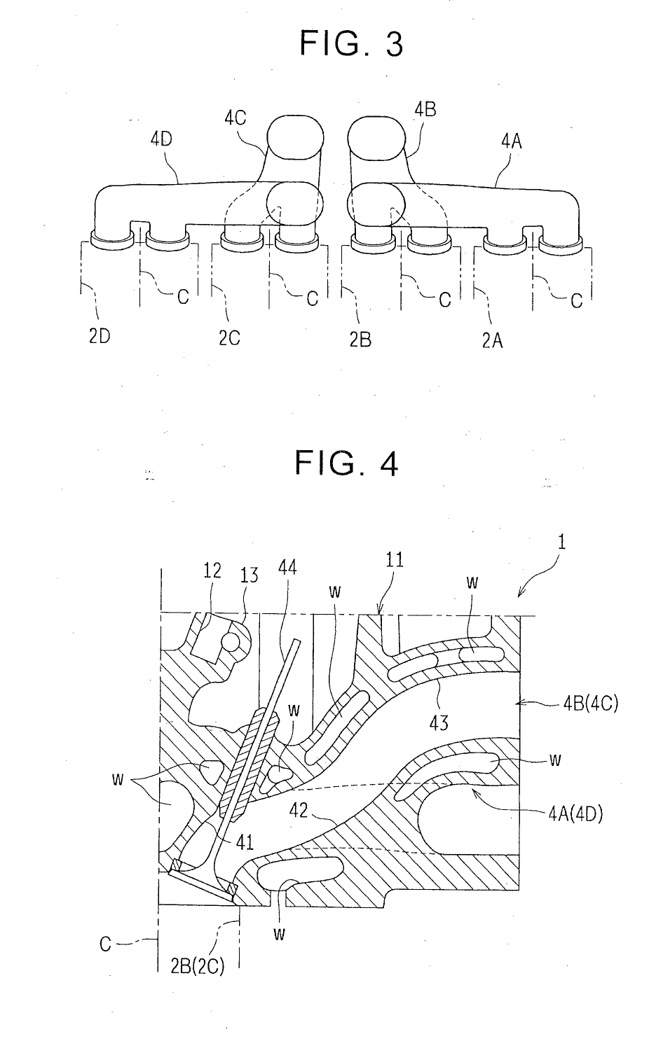

More specifically, the outer exhaust ports 4A and 4D respectively curve toward the inside in the cylinder row direction in the vicinities of the outer peripheries of the first and the second cylinders 2A and 2D; extend to the vicinity of the middle in the cylinder row direction, and then curve to the opposite directions to extend up to the fastener seat portion 11a adjacently to each other. On the other hand, the overall outer exhaust ports 4A and 4D generally horizontally extend to the fastener seat portion 11a when viewed from the exhaust side as shown in FIG. 3 or viewed in the cylinder row direction as shown in FIG. 4 with broken lines.

In other words, the outer exhaust ports 4A and 4D widely curving (with large radius of curvature) in the cylinder row direction are shaped to linearly extend to the fastener seat portion 11a instead of curving in the vertical direction such that the length of each port is not elongated too long. Accordingly, the outer exhaust ports 4A and 4D are constructed such that the heat radiation of the exhaust gas flowing within the exhaust ports does not excessively increase but a supercooling state does not occur.

The inner exhaust ports 4B and 4C (inner passages) which are respectively communicate with the second and the third cylinders 2B and 2C on the inner sides in the cylinder row directions generally linearly extend from the second and the third cylinders 2B and 2C to the fastener seat portion 11a of the side wall 11 on the exhaust side when viewed from above as shown in FIG. 2. Therefore, the inner exhaust ports 4B and 4C tend to be shortened in comparison with the outer exhaust ports 4A and 4D widely curving in the cylinder row direction as described above.

On the other hand, as it is apparent that when viewed from the exhaust side as shown in FIG. 3 and in the cylinder row direction as shown in FIG. 4, the overall inner exhaust ports 4B and 4C extend obliquely upward from the ceiling portions of the combustion chambers for the cylinders 2B and 2C, respectively. The inner exhaust ports 4B and 4C respectively extend over the downstream side of the outer exhaust ports 4A and 4D, and then open into the fastener seat portion 11a above the outer exhaust ports 4A and 4D. In other words, the inner exhaust ports 4B and 4C are opened on the far sides of the fastener seat portion 11a from the cylinders 2 in the direction of the cylinder center line C in comparison with the outer exhaust ports 4A and 4D.

As described above, because the downstream sides of the inner exhaust ports 4B and 4C extending obliquely upward climb over and extend above the outer exhaust ports 4A and 4D, the inner exhaust ports 4B and 4C are formed to be elongated accordingly, and whereas the length of the inner exhaust ports 4B and 4C is shorter than that of the outer exhaust ports 4A and 4D, the heat radiation of the exhaust gas is improved to a certain extent.

Thus, after the length of the inner exhaust ports 4B and 4C is extended as long as possible, the difference in the length with the outer exhaust ports 4A and 4D is reduced, or the heat radiation property is improved to a certain extent, the present embodiment can improve the heat radiation property by providing three curves 41 through 43 in the inner exhaust ports 4B and 4C.

In other words, as shown in FIG. 4 for the inner exhaust port 4B communicating with the second cylinder 2B, while the inner exhaust port 4B (4C) faces the cylinder 2B (2C) and extends from the upstream end opened in ,the ceiling portion of the combustion chamber toward the oblique upper right of FIG. 4, the inner exhaust port 4B (4C) starts to curve downward, and then is gradually directed to the horizontal direction to pass in the vicinity of the exhaust valve 44.

The inner exhaust port 4B (4C) curves upward from the height approximately the same as the height in which the outer exhaust port 4A (4D) extends horizontally, is gradually directed upward to extend obliquely upward, climbs over the outer exhaust port 4A (4D), and then curves downward again to generally horizontally extend to the fastener seat portion 11a.

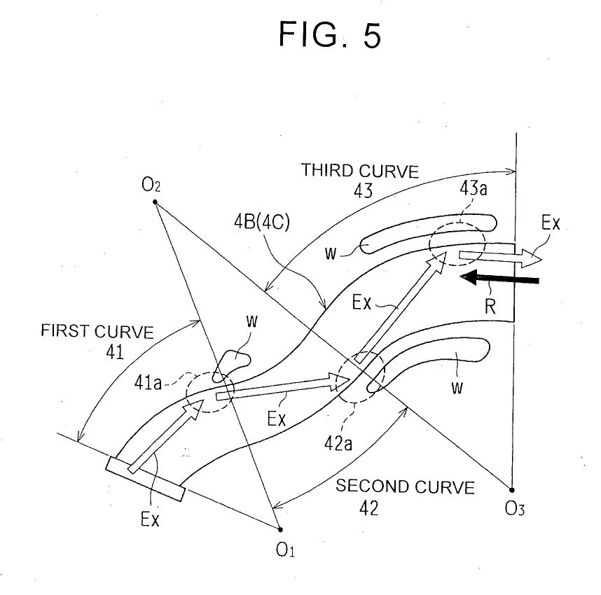

In other words, the inner exhaust port 4B (4C) is provided with, as schematically shown in FIG. 5, a first curve 41 that curves downward about a lower imaginary center O₁, a second curve 42 that curves upward about an upper. imaginary center O₂, and a third curve 43 that curves downward about a lower imaginary center O₃, in which these curves are alternately formed from the upstream side toward the downstream side of the exhaust gas flow. In other words, the inner exhaust port 4B (4C) has at least three curves each of which is a first curve (42) having a center (O₂) of curvature at a position closer to a cylinder center line than the exhaust gas flowing in the first curve or a second curve (41, 43) having a center (O₁ or O₃) of curvature at a position farther from the cylinder center line than the exhaust gas flowing in the second curve, the first curve and the second curve being located alternately in a direction toward the downstream sides of the exhaust gas flow. The exhaust gas flow in the inner exhaust port 4B (4C) as described above collides with wall surfaces of outer sides of the three curves 41 through 43 at curves as shown in FIG. 5 with hollow arrows Ex.

More specifically, an exhaust gas main stream Ex that is flown into the inner exhaust port 4B (4C) from a clearance with the exhaust valve 44 (see FIG. 4) collides with the downstream side of an upper surface in the first curve 41 (a wall surface of an outer side of the curve) to be directed downward, and then collides with the downstream side of a lower surface in the second curve 42 (a wall surface of an outer side of the curve) to be directed upward again. Then, the exhaust gas main stream Ex collides with the downstream side of an upper surface in the third curve 43 (a wall surface of an outer side of the curve) and flows approximately horizontally to be discharged from the inner exhaust port 4B (4C).

By a collision of the exhaust gas main stream Ex as described above, turbulence within a boundary layer increases in the vicinities 41a through 43a (shown with broken lines in FIG. 5) of the wall surfaces of the outer sides of the curves 41 through 43, and heat transfer is greatly accelerated due to the “turbulent diffusion.” That is, heat discharge Q of the exhaust gas is expressed in an equation of Q=heat transfer coefficient h×surface area A×temperature difference ΔT between temperatures of the exhaust gas and the wall surface, and therefore the heat radiation is improved in accordance with an increase in the heat transfer coefficient h at the first through the third curves 41 through 43 as described above.

As apparent from the above equation, when the velocity of the exhaust gas flow Ex colliding with the wall surfaces of the curves 41 through 43 gets faster, the colliding area gets larger, and the temperature difference gets larger, the heat radiation is improved higher. Therefore, in the present embodiment, the water jackets w formed in the cylinder head 1 are arranged to correspond to the portions with which the exhaust gas flow Ex collides in the first through the third curves 41 through 43.

In other words, as shown in FIG. 4 and FIG. 5, the water jackets w are provided at plural positions around the inner exhaust port 4B (4C) in the side wall 11 of the cylinder head 1 on the exhaust side. Specifically, as shown in FIG. 5, the water jackets w are provided in proximity to the wall surface of the outer sides of the curve so as to correspond to the downstream side of the exhaust gas flow (that is, a portion with which the exhaust gas flow Ex collides) in each of the first through the third curves 41 through 43.

In other words, the water jackets w are provided in the vicinity of the wall surface of the outer sides of each of the curves 41 through 43 where the heat transfer coefficient h increases due to the turbulent diffusion as described above, and when the temperature difference ΔT between those of the wall surface and the exhaust gas flow increases, the heat radiation property is synergistically improved. Specifically, backflow R may occur in the third curve 43 on an extreme downstream side due to pulsation of the exhaust gas flow, and accordingly, the exhaust gas flow exists in a steady state. Therefore, an enhancing effect of the heat radiation property is improved more.

Thus, according to the exhaust passage structure for the internal combustion engine of the present embodiment, three curves 41 through 43 are provided so as to alternately curve upward and downward toward the downstream side of the inner exhaust ports 4B and 4C that tend to be shortened in comparison with the outer exhaust ports 4A and 4D in the cylinder row direction out of four exhaust ports 4A through 4D which are arranged in a row in the longitudinal direction of the cylinder head 1, and the water jackets w are arranged to correspond to the curves 41 through 43. Accordingly, the heat radiation of the exhaust gas flow can be improved sufficiently.

The downstream side of the inner exhaust port 4B or 4C is formed to climb over and extend above the outer exhaust port 4A or 4D and also secure the length of the inner exhaust port 4B or 4C to a certain extent without curving to largely overhang in the vertical direction. Accordingly, the heat radiation property can be improved.

Therefore, the difference between the temperatures of the, exhaust gas in the inner exhaust ports 4B and 4C and the outer exhaust ports 4A and 4D can be reduced without upsizing the exhaust system, which in turn resulting in the increase of size or weight of the cylinder head 1. This contributes to the securement of durability reliability of the exhaust system and the improvement of warm-up property at a cold start, and it is preferable for on-board diagnosis system (OBD) detectability.

Furthermore, the inner exhaust ports 4B and 4C are alternately curved upward and downward in the three curves 41 through 43, the direction of the exhaust gas flow is not largely changed, and all the curves 41 through 43 are not curved sharply. Therefore, pressure loss does not increase so much, and the discharging efficiency of the exhaust gas with a high flow rate can be secured.

In addition, the exhaust gas is effectively cooled with the water jackets w provided in the vicinities of the three curves 41 through 43 in the inner exhaust port 4B or 4C as described above, and thus the volume of the water jackets w provided in other sections and the flow rate of the coolant can be reduced. Accordingly, the increase of the weight of the cylinder head 1 can be suppressed, and the load of a water pump can be also reduced.

### OTHER EMBODIMENTS

The structure of the present invention is not limited to the embodiments described above and can include other various forms. That is, in the embodiment described above, for example, the water jackets w are provided to correspond to the three curves 41 through 43 in the inner exhaust port 4B or 4C; however, the present invention is not limited to the aforementioned structure, and the water jackets w may be provided to correspond to any one of the curves 41 through 43.

In this case, the water jackets w are preferably provided in at least the third curve 43 on the extreme downstream side. This is because the exhaust gas flow exists in a steady state in the third curve 43 as described above, and therefore, the enhancing effect of the heat radiation property is improved more.

The number of the curves provided in the inner exhaust port 4B or 4C is not limited to three, and may be four, five, or more. The curving direction is not limited to the vertical direction (the direction of the center line C of the cylinder), and may be other directions as long as it includes the component of the vertical direction at least.

In addition, a step may be formed in the side wall of the outer side of the curve with which the exhaust gas flow collides in any of the three curves 41 through 43 in the inner exhaust port 4B or 4C so as to be shaped into steps along the direction of the exhaust gas flow. Accordingly, the turbulent diffusion of the exhaust gas flow that collides with the wall surface of the port is further enhanced, and the enhancing effect of the heat radiation property is improved more. When the increase of the pressure loss is considered, the existence of the large step is not so desirable, and therefore it is preferable that the height of the step do not cause the separation of the flow.

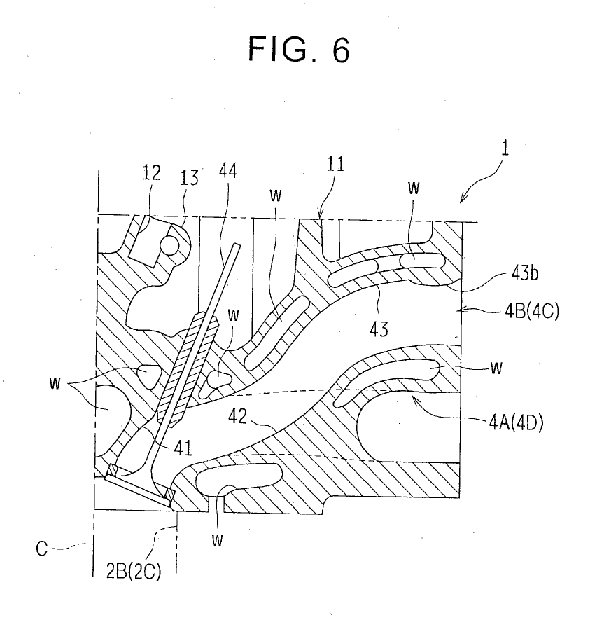

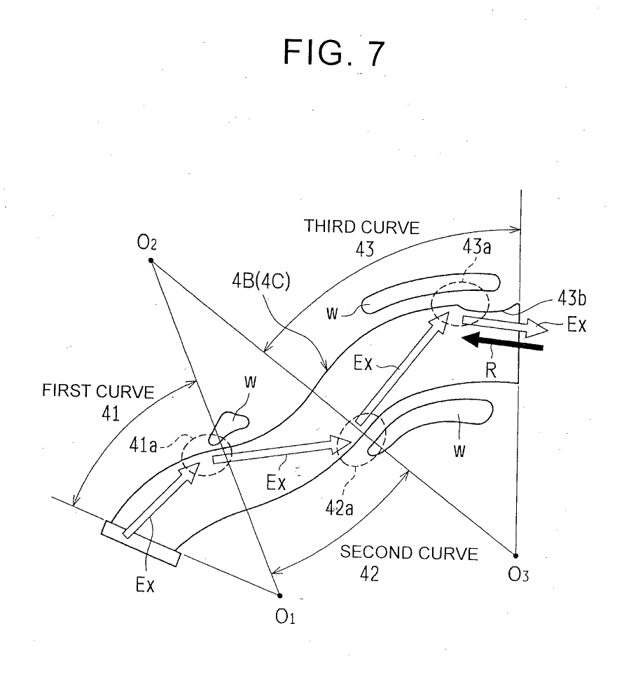

FIG. 6 shows an example in which a step 43b is provided at the third curve 43 in the inner exhaust port 4B or 4C so as to protrude from the wall surface of the outer side of the curve. As schematically shown in FIG. 7, the exhaust gas main stream Ex that collides with a lower surface of the second curve 42 to be directed upward collides with an upstream side step of the step 43b on the upper surface of the third curve 43, and thus the turbulence within the boundary layer increases.

As described above, the backflow R may occur in the third curve 43 due to the pulsation of the exhaust gas flow, and the exhaust gas flow exists in a steady state. Therefore, the enhancing effect of the heat radiation property through the provision of the step 43b is improved furthermore.

In addition, the aforementioned embodiment describes about a case where the present invention is applied to an in-line four-cylinder gasoline engine mounted on an automobile. However, the engine may be an in-line three-cylinder engine or an in-line engine with five or more cylinders. The engine may be a V-type engine in which three or more cylinders are arranged in a row in one bank or a horizontally opposed engine. Furthermore, the engine is not limited to the gasoline engine, and may be a diesel engine or a gas engine.

The above-described embodiments according to the present invention can reduce the temperature difference of the exhaust gas from multiple cylinders, improve the durability reliability of a catalyst or other components, and improve the warm-up property at the cold start without upsizing the exhaust system of the internal combustion engine in vain. Therefore, the embodiments are highly effective when applied to the internal combustion engine mounted on the automobile in particular.

1. An exhaust passage structure for an internal combustion engine comprising:
exhaust passages that respectively communicate with three or more cylinders of an internal combustion engine, the exhaust passages including two outer passages respectively communicating with the cylinders on outer sides in a cylinder row direction, the outer passages extending toward downstream sides of exhaust gas flow and curving to approach inner sides in the cylinder row direction; and an inner passage that communicates with the cylinder on inner side in the cylinder row direction, the inner passage having at least three curves each of which is a first curve having a center of curvature at a position closer to a cylinder center line than the exhaust gas flowing in the first curve or a second curve having a center of curvature at a position farther from the cylinder center line than the exhaust gas flowing in the second curve, the first curve and the second curve being located alternately and directly continuous with each other in a direction toward the downstream sides of the exhaust gas flow,
wherein
the outer passages curve toward a middle portion in the cylinder row direction at vicinities of the cylinders on the outer sides in the cylinder row direction, extend to the vicinities of the middle portion in the cylinder row direction, and then curve to opposite directions.

2. The exhaust passage structure for an internal combustion engine according to claim 1, wherein
the outer passages extend in horizontal directions.

3. The exhaust passage structure for an internal combustion engine according to claim 1, wherein
the inner passage extends obliquely upward from ceiling portions of combustion chambers, and a downstream side portion of the inner passage extends over the outer passage.

4. The exhaust passage structure for an internal combustion engine according to claim 1, wherein
a step is provided on a wall surface of an outer side of the curve in at least one of three or more curves in the inner passage so as to be shaped into steps along a direction of the exhaust gas flow.

5. The exhaust passage structure for an internal combustion engine according to claim 4, wherein
the step is provided in the curve on an extreme downstream side of the exhaust gas flow out of three or more curves.

6. The exhaust passage structure for an internal combustion engine according to claim 1, wherein
all the inner passage and the outer passages are formed in a cylinder head of the internal combustion engine, and a water jacket is provided in a vicinity of the wall surface of the outer side of each of three or more curves in the inner passage, a first water jacket provided in the vicinity of the wall surface of the outer side of one of three or more curves is located separately from a second water jacket provided in the vicinity of the wall surface of the outer side of the other of three or more curve, in cross-section of the cylinder head passing through a center of the inner passage.

7. The exhaust passage structure for an internal combustion engine according to claim 6, wherein
the water jacket is provided in a vicinity of the downstream side of the exhaust gas flow in at least one of the curves.

8. The exhaust passage structure for an internal combustion engine according to claim 6, wherein
the water jacket is provided in a vicinity of the curve on an extreme downstream side of the exhaust gas flow out of three or more curves.

9. The exhaust passage structure for an internal combustion engine according to claim 6, wherein
downstream ends of the exhaust gas flow in the two outer passages are adjacently opened in a side wall of the cylinder head in the cylinder row direction, and downstream end of the exhaust gas flow in the inner passage is opened on a far side from the cylinders in the direction of the cylinder center line with respect to downstream end openings of the outer passages in the side wall of the cylinder head.

10. The exhaust passage structure for an internal combustion engine according to claim 5, wherein
the step is provided in only the curve on an extreme downstream side of the exhaust gas flow out of three or more curves.
